(19) United States
(12) Patent Application Publication
(10) Pub. No.: US 2006/0216687 A1
(43) Pub. Date: Sep. 28, 2006

(54) Reconstitutable dried blood products

(76) Inventors: Odilio Alves-Filho, Trondheim (NO); Ola Bergslien, Trondheim (NO); Peter Bjork, Trondheim (NO); Trygve Magne Eikevik, Trondheim (NO); Ingvald Strommen, Trondheim (NO)

Correspondence Address: SUGHRUE MION, PLLC, 2100 PENNSYLVANIA AVENUE, N.W., SUITE 800, WASHINGTON, DC, 20037, US

(21) Appl. No.: 10/540,520

(22) PCT Filed: Dec. 24, 2003
(86) PCT No.: PCT/GB03/05670

§ 371 Date: Apr. 11, 2006

(30) Foreign Application Priority Data
Dec. 24, 2002 (GB) 0230152.1

(51) Int. Cl. A01N 1/02

(52) U.S. Cl. 435/2

(57) ABSTRACT

The invention provides a process for the preparation of a dried particulate blood product the particles whereof comprise anuclear blood cells in a protective agent, said process comprising: obtaining a blood sample from a mammalian subject; adding an anticoagulant to said sample; concentrating the cells of said sample; recovering a concentrate containing anuclear blood cells from said sample; impregnating with said concentrate a particulate comprising a macromolecular protective material; drying the impregnated particulate at a temperature in the range of −20 to +120° C.; and, optionally, packaging the dried particular in sealed containers.

The present invention relates to reconstitutable dried blood products, processes for their preparation and reconstitution, and their medical and non-medical (e.g. research) uses.

Hospitals carry stocks of blood products (e.g. erythrocyte concentrates, platelets, plasma, etc.) for use for example during surgical procedures. Blood products containing anuclear blood cells (i.e. cells without nuclei, such as erythrocytes and platelets) deteriorate rapidly. Platelets degrade very quickly as they are stored at ambient temperature and erythrocytes deteriorate very rapidly if not chilled and stored in refrigerators at about 1 to 4° C. Even refrigerated, such blood products deteriorate and must be discarded after a short time, e.g. three to six weeks for erythrocytes (red blood cells) or four hours to seven days for platelets, as the anuclear cells have died, deteriorated or substantially disappeared or as the risk of bacterial infection has increased to an unacceptable level.

Health authorities and hospitals thus generally rely on a continuous collection, separation and storage of blood to meet their normal needs, and, in order to maintain supplies at maximum levels, surgeons demanding blood products are routinely supplied with the oldest supplies still within their permitted storage times, i.e. supplies which are in sub-optimal condition. Where supplies are insufficient to meet demand, e.g. in the case of an event with many casualties or where an individual with a rare blood group is in need of large quantities of a compatible blood product, fresh supplies need to be transported from remote locations, thereby risking patients' lives if opportunities for supply and transport are restricted.

As a result, in the case of a major accident or of an event with large numbers of casualties, hospitals and health authorities risk having an inadequate supply of blood products available for transfusions. In such circumstances, the hospitals and health authorities cannot rely upon being able to recruit donors and to collect sufficient blood within the necessary time—not least because the donors' blood must be checked for any disease (e.g. HIV infection) before it is used.

While it is possible to cryogenically store certain cells for long periods, e.g. in liquid nitrogen at −196° C., this is not true for anuclear cells unless exogenous cryoprotectants and complex and expensive freezing and reconstitution processes are used. Such procedures are not only complex but are not generally applicable for disaster areas or areas of military conflict where the necessary continuous and reliable supplies of electricity and liquid nitrogen will not normally be available.

Conventional freezing techniques are quite simply not feasible for anuclear cell-containing blood products. Thus for example W. Tousel, in the discussion appended to his paper with H. Hindorf in “Principes et applications de la lyophilisation des produits biologigues, pharmaceutiques et alimentaires”, Science et Technique du Froid, Tokyo, Japan, 1985, pages 287-292, when asked whether he had experience of freeze-drying such products replied “It is not possible to freeze dry such sensitive blood cells as platelets and erythrocytes. These cells can be preserved by liquid preservation such as the liquid nitrogen method with some cell loss”. The same discussion advised that red blood cells could be preserved by freezing at −28° C. with a glycerol content of 25% or by other freezing techniques using temperatures between −196° C. and −80° C.

The use of glycerol or other cryoprotectants is clearly undesirable as they must be removed before the blood product is administered by transfusion and, as mentioned above, cryogenic techniques require complex and expensive equipment, materials and processes which are generally not available or feasible at disaster sites (e.g. earthquake, volcano or major accident sites) or during military operations.

There is thus a need for such blood products which can be stored for periods longer than is currently possible and yet can be rapidly reconstituted for transfusion into a patient when the need arises, e.g. when supplies of blood products of the correct type are exhausted. Moreover there is an additional demand for blood products that are a safer and more reliable alternative to the materials currently available for transfusions. Furthermore, the logistics for blood products both in remote regions and large urban centres are complicated by the bulk of the current products and their refrigeration requirements.

We have now surprisingly found that it is possible to produce dried anuclear cell-containing blood products, to store these under ambient conditions or relatively mild refrigeration, and to reconstitute the products to produce a transfusion fluid containing viable cells even after storage periods significantly in excess of the maximum storage period for equivalent refrigerated blood products.

Thus viewed from one aspect the invention provides a dried particulate blood product the particles whereof comprise anuclear blood cells in a macromolecular protective material.

The dried product, on dissolution in a physiologically tolerable aqueous solution to an osmolality within the range normal for the relevant species' blood and at a temperature within 1° C. of the normal day time body temperature of the relevant species, contains intact viable cells.

Viewed from a further aspect the invention provides a process for the preparation of a dried particulate blood product the particles whereof comprise anuclear blood cells in a protective agent, said process comprising:

obtaining a blood sample from a mammalian (e.g. human) subject;

adding an anticoagulant to said sample;

concentrating the cells of said sample;

recovering a concentrate containing anuclear blood cells from said sample;

impregnating with said concentrate a particulate comprising a macromolecular protective material;

drying the impregnated particulate at a temperature in the range −20 to +120° C. (preferably −10 to +40° C. but up to 120° C. is feasible for high temperature driers);

and optionally packaging the dried particulate in sealed containers, especially containers substantially free of oxygen in any head space, e.g. by vacuum packing.

The macromolecular protective material used in the invention is preferably a material containing a water-soluble macromolecular substance having a molecular weight in excess of 1000 D, especially above 2000 D and more especially a mixture of such substances. The material preferably contains macromolecules endogenous to the species from which the blood derives, in particular materials selected from polysaccharides, proteins (including glycoproteins) and lipids (e.g. phospholipids). Especially preferably the material contains macromolecules naturally occurring in the blood of the species from which the blood derives, e.g. plasma proteins, intracellular proteins, and cell membrane molecules (e.g. proteins and lipids, etc). More especially, the material preferably comprises cell membrane molecules from anucleic blood cells, in particular erythrocytes. Especially preferably, the material comprises spectrin. In an especially preferred embodiment, the protective material is substantially haemoglobin-free, e.g. with a haemoglobin content of less than 50% wt, preferably less than 25% wt, more preferably less than 10% wt, especially less than 1% wt relative to the haemoglobin content of erythrocytes (on a dry solids basis).

The drying of the impregnated particulate is preferably effected at a temperature in the range −5 to +37° C., more especially −1 to 25° C., particularly 0 to 15° C., more particularly 1 to 10° C., e.g. 3 to 5° C. The duration of the drying process will depend upon the drying technique used but will preferably not exceed 10 hours. A drying period of up to 8 hours is preferred.

Drying is preferably effected so as to achieve a total moisture content in the dried product of 1 to 20% wt, more preferably 2 to 17% wt, especially 5 to 12% wt, more especially 7 to 10% wt.

Drying may be effected by any suitable procedure, e.g. vacuum drying, spray drying, fluidized bed drying, rotary drying, agitated bed drying, continuous belt drying, etc. However the technique used is preferably one which subjects the cells to a minimum of physical stress and accordingly fluidized bed drying is especially preferred.

In the drying procedure, conventional drying media (e.g. air, nitrogen, etc.) may be used; however it is preferred to use nitrogen, reduced oxygen content air, or noble gases.

The gas pressure in the drying procedure is preferably within 10% of ambient air pressure.

In place of conventional fluidized bed driers, where gas is used to fluidize the particle bed, in the process of the invention one may use instead a drier in which the bed is fluidized mechanically, e.g. by counter-rotating parallel arms carrying screws or paddles. Such mechanically fluidized beds have been used for example in the polymer industry for impregnation of metallocene catalysts into particulate carriers (see for example patent applications from Borealis). If mechanical fluidization is used, the gas pressure in the drier is preferably sub-ambient.

The particles that are impregnated in the process of the invention are preferably in solid or gel form, particularly solid form. The particle size (i.e. mode particle diameter) is preferably in the range 0.05 to 5 mm, more especially 0.5 to 3 mm. Accordingly, if desired, the particles may be graded (e.g. sieved) before use to select particles of the desired size. Substantial uniformity of particle size results in substantially uniform drying of the impregnated particles and thus minimizes the stress to which the anuclear cells are exposed during drying.

Impregnation of the particles may be achieved by any suitable method, e.g. by spraying or dripping the concentrate onto the particles, by immersing the particles in the concentrate, or by passing a curtain of falling concentrate over the particles (i.e. by moving the curtain or the particles or both). Preferably a technique is used which exposes the anuclear cells to minimal mechanical stress, e.g. dripping or using a falling curtain. If desired the particles may be agitated during the impregnation procedure, e.g. mechanically or by gas flow (as for example in a vibrated or fluidized bed).

The particles used are desirably porous (e.g. with a pore size or interstitial gaps in excess of 10 μm) and/or water-swellable.

Particle impregnation may alternatively, but less preferably, be effected by mixing the concentrate with a solution of the protective material and gelling droplets of the resulting mixture, e.g. by dripping or spraying the mixture into an environment in which the mixture forms a gel, e.g. a solution which contains an agent which interacts with a component of the mixture to form a gel. Thus for example the mixture may include an alginate and on dripping or spraying into a calcium salt solution this will form droplets of a gel.

In an alternative aspect of the invention the particulate protective material may be impregnated with a liquid (generally aqueous) solution, dispersion or suspension of nucleus-containing eukaryotic cells (preferably mammalian cells, in particular human cells) and then dried to produce a reconstitutable biological product.

Viewed from a further aspect therefore the invention provides a dried, reconstitutable biological product comprising nucleus-containing eukaryotic cells in a macromolecular protective material.

Viewed from a still further aspect the invention provides a process for the preparation of a dried, reconstitutable biological product which process comprises impregnating a particulate macromolecular protective material with a liquid containing nucleus containing eukaryotic cells, and drying the impregnated particulate.

Especially preferably the reconstitable biological product (i.e. a product which can be rehydrated to a material with the desired biological activity) is a dried stem cell product.

The anticoagulant used in the process of the invention is preferably one which inhibits cell aggregation and/or one which operates to inhibit fibrin formation. One example of a suitable anticoagulant is citrate. The use of anticoagulants following blood collection for the preparation of transfusable blood products is a conventional practice. Typical anticoagulants used in practice include CPD, CP2D, CPDA-1, AS-1, AS-3 and AS-5.

The cell concentration step in the process of the invention may be any suitable cell concentration procedure, e.g. filtration. However centrifugation is preferably used. Centrifugation is conventionally used following blood donation to produce blood cell concentrates and cell-free plasma which are separated before being stored. Centrifugation, optionally several cycles of centrifugation, is also conventionally used to produce concentrates of the different types of cells found in blood, e.g. erythrocytes, platelets, granulocytes, monocytes, lymphocytes, B cells, T cells and NK cells, as in certain surgical procedures (e.g. organ transplantation) it is not always desirable for the cell-containing transfusion fluid to contain the different types of cells in their normal ratios. The cell-containing concentrate used in the process of the present invention may contain platelets and/or erythrocytes and optionally other blood cells and blood proteins, etc. Preferably however it contains nucleus-containing cells at an abundance relative to the anuclear cells which is less than that in blood. To this end the cell concentration step may involve several cycles of centrifugation, separation, dilution, centrifugation, etc. so as to increase the relative abundance of the desired cell types in the final concentrate. In general, particularly in preparing a red blood cell product, it may be desirable to reduce leucocyte and cytokine concentration before centrifugation, e.g by using an in-line leucocyte reduction filter (available from Baxtor Healthcare).

Following cell concentration, the concentrate may be stored under refrigeration (e.g. 1 to 4° C.) for up to 35 days before further processing. However the concentrate is preferably further processed with minimal delay, preferably no more than 7 days, more preferably no more than 24 hours.

To optimize the viability of the cells in the blood products of the invention, it is desirable that there should be as little delay as possible between blood collection and the product drying stage and that during any period between process steps the intermediate product be stored under refrigeration (e.g. 1 to 4° C.).

While the invention is applicable to blood from all animals having a vascular system, it is especially applicable to mammalian blood, and in particular human blood.

In the sample collection stage, blood is preferably collected from healthy donors, e.g. using international recommendations from the relevant health authorities or, in Norway, from the Norwegian Health Ministry. Typically, for human blood, the sample volume per donor will be in the range of 100 to 800 mL, more preferably 200 to 600 mL, e.g. 400 to 500 mL, especially 440 to 480 mL. Blood from the donor will preferably be screened for infection, especially viral infection, in particular hepatitis B, hepatitis C and HIV. Where screening shows the blood to be infected, the sample should be rejected, unless the dried product is designated for the use of the donor only. Generally however all infected samples will be rejected. Nonetheless, since the dried products according to the invention are more readily susceptible to a range of decontamination techniques than whole blood or liquid blood component samples, e.g. irradiation, gas exposure, etc., it may not be necessary to reject blood samples found to contain disease markers. The blood should be collected, stored and handled under sterile conditions and using sterile equipment. To the collected blood should be added an anticoagulant as mentioned above. Typically for a 450 mL sample of blood this might involve collection into 63 mL of a sterile aqueous citrate/phosphate/dextrose solution (e.g. CPD, CP2D or CPDA-1). If the sample is not to be further processed immediately it is desirably stored under refrigeration, e.g. at 1-4° C. Blood collection is described for example in Chapter 11 of “Basic and Applied Concepts of Immunohaematology” by Blaney et al, Mosby, 2000.

The sample is then subjected to cell concentration, e.g. using a conventional centrifuge. The resulting cell suspension may then be processed further immediately or stored under refrigeration (e.g. 1-4° C.) for up to five weeks before further processing.

The cell concentration step may if desired be used to collect all blood cell types; however, if desired, only specific blood cell types, e.g. erythrocytes, platelets, stem cells, granulocytes or lymphocytes, may be collected if the final product is desired to contain such specific cells rather than the whole spectrum of blood cells.

The plasma may if desired also be collected and further processed to collect blood proteins (e.g. plasma proteins, in particular gamma globulins and albumin and coagulation factors) and cellular constituent materials, etc. Such materials may be collected and concentrated using standard techniques, e.g. affinity chromatography and other known separation techniques.

Particularly where the cell concentration step is used to separate cells with nuclei from those without, the concentrate may then be sterilized using techniques lethal to cells with nuclei, e.g. irradiation, etc. This can be done on the concentrate or on the product at any subsequent stage in its preparation, packaging and storage.

The dried particulate blood product is conveniently packaged into containers which are then sealed. Preferably the gas in the sealed containers is oxygen-free, e.g. nitrogen or helium. The sealed containers may be stored at ambient temperature but desirably are stored frozen or under refrigeration or freezing, e.g. −20 to +10° C., preferably −10 to +4° C.

The dried product may be reconstituted by mixing with a sterile aqueous solution, preferably one which, in combination with the dried product, will yield a solution which is within 10% of being iso-osmolar with blood, e.g. corresponding to 0.8 to 1.0% saline. Particularly desirably, the reconstitution fluid contains the major metal cations present in plasma, i.e. sodium, calcium, potassium and magnesium. Also desirably the reconstitution fluid contains glucose, adenosine triphosphate and 2,3-diphosphoglycerate.

In order to optimize storage and reconstitution, the mean particle size (expressed for example in D(v, 0.5)) for the protective material particles which are impregnated in the process of the invention is preferably in the range 0.05 to 5 mm, especially 0.5 to 3 mm. If necessary therefore, the protective material may be sized, e.g. sieved, to select a particulate fraction having particle sizes of the desired magnitude.

Where the protective agent used in the preparation of the dried blood product is not physiologically tolerable in the quantities used, reconstitution will involve complete or partial removal of the protective agent. To achieve this, the product may be dissolved in the reconstitution fluid and then centrifuged one or more times with the sedimented cells being recovered and diluted with further reconstitution fluid. Alternatively the dissolved product may be filtered with the retentate, i.e. the cells, being recovered and if necessary diluted with further reconstitution fluid. In another alternative procedure, the dissolved product may be dialysed using a membrane which permits transfer of the protective agent.

Thus viewed from a further aspect the invention provides a method of production of a transfusion liquid, said method comprising dispersing a dried particulate blood product according to the invention in a physiologically tolerable sterile aqueous solution and if necessary treating the resulting dispersion to reduce the content therein of the protective material.

Viewed from a further aspect the invention provides a kit comprising a first container containing a dried particulate blood product according to the invention, and a second container containing a sterile physiologically tolerable aqueous reconstitution solution.

Where it is desired that the transfusion liquid contain more than one type of blood component, e.g. erythrocytes, platelets, and plasma proteins, it is possible to use a combination of separately produced dried blood products. The combination may be brought together before or after reconstitution. Mixing before reconstitution is feasible where the protective materials used do not have to be removed or where they may be removed without separating the different blood products. Thus for example, where a protective material has a low molecular weight, e.g. below 500 D, centrifugation or dialysis might be used. For this purpose a conventional blood cell processor may be used.

The process of the invention is especially suited to the production of such combination transfusion fluids. Thus centrifugation of the original blood sample may be effected in a series of stages, at each successive stage using a higher g-force whereby to separate out progressively lower weight blood components. As a result, to collect plasma proteins for example, g-forces which would cause erythrocytes to rupture may be used since by this stage the sample will be cell-free.

Thus while the invention is primarily directed to the production of dried, anuclear cell-containing particulate products, as mentioned above it may also be used to produce dried particulates containing other blood components, especially cell fragments and other cell constituents. The invention may also be used to produce dried particulate compositions containing mammal cells other than blood cells, e.g. bone marrow cells, foetal or embryonic cells (especially stem cells), etc. Especially preferably the product contains mesenchymal stem cells (MSC), e.g. from adult bone marrow, or hematopoietic stem cells from peripheral blood. MSCs are particularly useful since they are less subject to rejection by recipients. Such products, their production and their use also form aspects of the present invention.

Using the procedure of the invention it is possible to produce dried products containing cells which are still viable after more than four months and even up to 10 years after removal from the body.

A further advantage of the dried product of the invention, besides its prolonged shelf life, is the fact that it requires less storage space than whole blood. Thus large quantities can be stored or moved to a location where a demand for blood has arisen, more easily than whole blood.

The invention will now be described further with reference to the following non-limiting Examples.

### EXAMPLE 1

Preparation of Macromolecular Protective Material

Frozen red blood cell concentrate was cooled further in liquid nitrogen, warmed to −25° C., and then grated. The resulting particulate was sieved to a particle size of 0.5 to 2 mm. The particulate was vacuum freeze-dried at −30° C. to yield a dry powder. This was warmed to 20° C. and stored.

Further powder was prepared analogously by fluidized bed drying at −20° C. and by using both drying techniques on material for which the liquid nitrogen treatment was omitted.

### EXAMPLE 2

Preparation of Dried Erythrocyte Containing Product

At 2° C., a liquid red blood cell concentrate (prepared by centrifugation of citrated blood) was dripped onto the powder of Example 1. The resulting impregnated powder was then dried in a fluidized bed dryer at 4° C. over 6 hours to a moisture content of about 8% wt.

### EXAMPLE 3

Reconstitution of Dried, Erythrocyte Containing Product

100 μL of phosphate buffered saline was added to approximately 4 μL of a dried erythrocyte-containing product produced as described in Example 2 and having particle sizes in the range 0.01 to 5 mm. The product had been vacuum packed and stored under ambient conditions for more than 120 days since blood collection. Viewed under a light microscope (Reichert, Austria) after about 5 minutes, the reconstituted suspension was seen to contain cells.

### EXAMPLE 4

Production of Haemoglobin Free Protective Material

Concentrated red blood cells are diluted with water for injections so as to cause the cells to lyse. If desired a bipolar electrical field (e.g. having a voltage gradient in excess of 1000 V/cm) may be applied to cause cellular electrophoresis. The dilute mixture is centrifuged or ultra-centrifuged and the macrostructure/macromolecule fraction below the haemoglobin band is separated out. The separated fraction is again diluted with water for injections and centrifuged. This is repeated until the separated fraction no longer has the red colour associated with haemoglobin or has a colour which is much reduced in intensity. The separated fraction is then solidified by freezing, pulverized, sieved and dried as in Example 1. The resulting powder may then be used as in Examples 2 and 3.

1. A process for the preparation of a dried particulate blood product the particles whereof comprise anuclear blood cells in a protective agent, said process comprising:
obtaining a blood sample from a mammalian subject;
adding an anticoagulant to said sample;
concentrating the cells of said sample;
recovering a concentrate containing anuclear blood cells from said sample;
impregnating with said concentrate a particulate comprising a macromolecular protective material;
drying the impregnated particulate at a temperature in the range of −20 to +120° C.; and, optionally, packaging the dried particulate in sealed containers.

2. The process as claimed in claim 1, wherein said blood sample is obtained from a human subject.

3. The process as claimed in claim 1, wherein said macromolecular protective material contains a water-soluble macromolecular substance having a molecular weight above 2000 D.

4. The process as claimed in claim 1, wherein said macromolecular protective material contains macromolecules naturally occurring in the blood of the species from which the blood derives.

5. The process as claimed in claim 1, wherein said macromolecular protective material has a hemoglobin content of less than 1% wt relative to the hemoglobin content of erythrocytes.

6. The process as claimed in claim 1, wherein the drying step is effected at a temperature between 1 and 10° C.

7. The process as claimed in claim 1, wherein the drying step involves fluidized bed drying.

8. A dried particulate blood product the particles whereof comprising anuclear blood cells in a macromolecular protective material.

9. A dried, reconstitutable, biological product comprising nucleus-containing eukaryotic cells in a macromolecular protective material.

10. A process for preparation of a dried, reconstitutable biological product which process comprises impregnating a particulate macromolecular protective material with a liquid containing nucleus containing eukaryotic cells and drying the impregnated particulate.

11. A method of production of a transfusion liquid, said method comprising dispersing a dried particulate blood product according to claim 8 or claim 9 in a physiologically tolerable sterile aqueous solution and optionally treating the resulting dispersion to reduce the content therein of the protective material.

12. A kit comprising a first container containing a dried particulate blood product according to claim 8 or claim 9, and a second container containing a sterile physiologically tolerable aqueous reconstitution solution.

13. A kit as claimed in claim 12, wherein said first container is disposed in said second container and is openable whereby to release its contents into said solution.
